(19) United States
(12) Patent Application Publication
(10) Pub. No.: US 2015/0287419 A1
(43) Pub. Date: Oct. 8, 2015

(54) SPEAKER APPARATUS AND SPEAKER SYSTEM

(71) Applicant: ISSC Technologies Corp., Hsinchu City (TW)

(72) Inventors: YI-LUNG CHEN, HSINCHU CITY (TW); SHYH-MING HUANG, HSINCHU COUNTY (TW)

(73) Assignee: ISSC Technologies Corp., Hsinchu City (TW)

(21) Appl. No.: 14/289,603

(22) Filed: May 28, 2014

(30) Foreign Application Priority Data
Apr. 2, 2014 (TW) 103112300

(51) Int. Cl. G10L 19/04; H04R 3/12

(52) U.S. Cl. CPC G10L 19/04; H04R 3/12

(57) ABSTRACT

The present disclosure illustrates a speaker apparatus and a speaker apparatus system, wherein the speaker apparatus includes a communication unit, an audio codec, a sound unit and a clock unit. The audio codec is coupled to the communication unit. The sound unit is coupled to the audio codec. The clock unit is coupled to the communication unit. The communication unit is configured for wirelessly receiving and broadcasting audio data. The audio codec is configured for decoding the audio data and generating an analog signal according to the decoded audio data. The sound unit is configured for transforming the analog signal into an acoustic wave. The clock unit synchronizes with at least one other speaker apparatuses by a synchronous signal.

### BACKGROUND

1. Technical Field

The present disclosure relates to a speaker apparatus, in particular, to a speaker apparatus and speaker system thereof having a wireless transmission function.

2. Description of Related Art

At present, as the computer and information industry rapidly develops, various new peripheral devices can be easily connected to the mobile devices which almost everybody owns, such as personal computers, laptop computers, tablet computers or smart phones. Connecting various peripheral devices to electronic devices provides people with a more diversified life.

Therefore, users can play joyful music or movies on their mobile devices anytime and anywhere. For example, users can connect earphones to the mobile device to enjoy their personal music, or the user can connect the mobile device to a speaker apparatus for sharing music with others.

The price and volume of high end peripheral apparatuses are often a heavy burden for users. A sound amplification apparatus is a common example. A good speaker system is usually installed with multiple sound cabinets for creating a stereo effect, a surround sound effect, or a heavy bass effect. However, generally, it is hard to adjust a set of speaker sound cabinets to the user's requirements. For example, when a user only has a limited budget it is hard for the user to bear the cost of a more expensive whole set of speaker sound cabinets, and the user would probably just buy one speaker sound cabinet, making it hard to sell a whole set of speaker sound cabinets.

### SUMMARY

An exemplary embodiment of the present disclosure provides a speaker apparatus which comprises a communication unit, an audio codec, a sound unit and a clock unit. The audio codec is coupled to the communication unit. The sound unit is coupled to the audio codec. The clock unit is coupled to the communication unit. The communication unit is configured for wirelessly receiving and broadcasting audio data. The audio codec is configured for decoding the audio data and generating an analog signal according to the decoded audio data. The sound unit is configured for transforming the analog signal into an acoustic wave. The clock unit synchronizes with another speaker apparatus by the synchronous signal.

An exemplary embodiment of the present disclosure provides a speaker apparatus which comprises a communication unit, an audio codec, and a sound unit. The audio codec is coupled to the communication unit, and the sound unit is coupled to the audio codec. The communication unit is configured for receiving audio data which has been broadcasted. The audio codec is configured for decoding the audio data and generating an analog signal according to the decoded audio data. The sound unit is configured for transforming the analog signal into an acoustic wave. The speaker apparatus synchronizes with the first speaker apparatus by a synchronous signal generated from the first speaker apparatus.

An exemplary embodiment of the present disclosure provides a speaker apparatus transmission system which comprises a first speaker apparatus and a second speaker apparatus. The first speaker apparatus comprises a first communication unit, a first audio codec, a first sound unit and a clock unit. The second speaker apparatus comprises a second communication unit, a second audio codec and a second sound unit. The first audio codec is coupled to first the communication unit, and the first sound unit is coupled to first the audio codec, and the clock unit is coupled to the first communication unit. The first communication unit is configured for wirelessly receiving and broadcasting second audio data. The first audio codec is configured for decoding the audio data and generating a first analog signal according to the decoded audio data. The first sound unit is configured for transforming the first analog signal into an acoustic wave. The clock unit generates a synchronous signal. The second audio codec is coupled to the second communication unit, and the second sound unit is coupled to the second audio codec, and the clock unit is coupled to the second communication unit. The second communication unit is configured for receiving audio data which has been broadcasted. The second audio codec is configured for decoding the audio data and generating a second analog signal according to the decoded audio data. The second sound unit is configured for transforming the second analog signal into an acoustic wave. The second speaker apparatus synchronizes with the first speaker apparatus by a synchronous signal generated from the clock unit of the first speaker apparatus.

To sum up, the speaker apparatus, speaker system and speaker apparatus transmission system according to the present disclosure allows for the user to assemble a speaker system in a more flexible way. In more detail, the user can adjust whatever required amount of speaker apparatuses desired by himself or herself upon his/her demand according to the disclosed way of combining a master speaker apparatus and a slave speaker apparatus. On the other hand, the problem that internal amplifiers connected in series will overload and make audio data transmission between speaker apparatuses more difficult when multiple traditional speaker apparatuses are connected in series, can be prevented by wirelessly broadcasting the audio data.

In order to further understand the techniques, means and effects of the present disclosure, the following detailed descriptions and appended drawings are hereby referred to, such that, and through which, the purposes, features and aspects of the present disclosure can be thoroughly and concretely appreciated, however, the appended drawings are merely provided for reference and illustration, without any intention that they be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram of a master speaker apparatus of an embodiment according to the present disclosure;

FIG. 2 is a schematic view of the master speaker apparatus of the embodiment according to the present disclosure;

FIG. 3 is a block diagram of a slave speaker apparatus of an embodiment according to the present disclosure;

FIG. 4 is a schematic view of the slave speaker apparatus of the embodiment according to the present disclosure;

FIG. 5 is a schematic view of a practical application of the embodiment according to the present disclosure;

FIG. 6 is a schematic view of the practical application of the embodiment according to the present disclosure;

FIG. 7 is a block diagram of a speaker apparatus of another embodiment according to the present disclosure;

FIG. 8 is a schematic view of the speaker apparatus of the embodiment according to the present disclosure.

### DESCRIPTION OF THE EXEMPLARY EMBODIMENTS

Reference will now be made in detail to the exemplary embodiments of the present disclosure, examples of which are illustrated in the accompanying drawings. However, they may be embodied in different forms and should not be construed as limited to the embodiments set forth herein. In the drawings, the thickness and relative thickness of layers and regions may be exaggerated for clarity. Wherever possible, the same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of the embodiments. As used herein, the term “or” includes any and all combinations of one or more of the associated listed items.

The speaker apparatus transmission system of an embodiment according to the present disclosure comprises a master speaker apparatus and a slave speaker apparatus. The master speaker apparatus is configured for connecting to a media apparatus and receiving audio data transmitted from the media apparatus, and broadcasting the received audio data to other slave speaker apparatus in neighborhood. The illustration of detailed components and operation of the master speaker apparatus and the slave speaker apparatus will be described respectively in the following paragraphs.

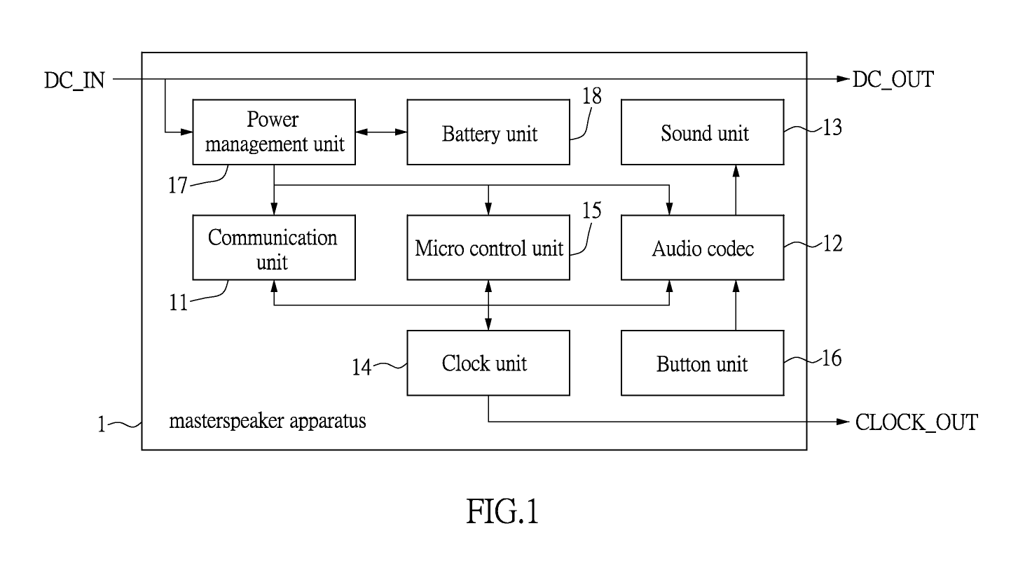

Please refer to FIG. 1 which is a block diagram of a master speaker apparatus of an embodiment according to the present disclosure. The master speaker apparatus 1 comprises a communication unit 11, an audio codec 12, a sound unit 13, a clock unit 14, a micro control unit 15, a button unit 16, a power management unit 17 and a battery unit 18. The audio codec 12, the micro control unit 15 and the communication unit 11 are coupled to each other. The clock unit 14 is coupled to the communication unit 11, the audio codec 12 and the micro control unit 15. The power management unit 17 is coupled to the communication unit 11, the audio codec 12 and the micro control unit 15, and the battery unit 18 is coupled to the power management unit 17. The sound unit 13 is coupled to the micro control unit 15, and the button unit 16 is coupled to the micro control unit 15.

The communication unit 11 is configured for wirelessly receiving and broadcasting audio data, and receiving or transmitting a synchronous signal. For example, the master speaker apparatus 1 can be connected to a smart phone or a tablet computer when it is desired to play audio through the communication unit 11 in a wireless transmission way such as Wi-Fi or a Bluetooth signal. The audio of the smart phone or the tablet computer is then received and played on the master speaker apparatus 1. The master speaker apparatus 1 performs a digital signal process such as an equalization process and a channel separating process, on the received audio and plays the processed audio by the sound unit 13. In addition, the master speaker apparatus 1 further broadcasts the audio data received by the communication unit 11 to the slave speaker apparatus in the neighborhood. The problem that internal amplifiers connected in series will overload and make audio data transmission between speaker apparatuses more difficult, when multiple traditional speaker apparatus are connected in series for transmitting audio data, can be prevented by wirelessly broadcasting the audio data.

The audio codec 12 receives the audio data from the micro control unit 15, and decodes the audio data. For example, the audio codec 12 can adopt a codec for the MP3 format. On the other hand, the audio codec 12 comprises an analog-to-digital converter which can convert the decoded binary (I/O) digital signal to an analog electronic signal. The decoded digital signal may be further processed by the digital signal process if necessary. In other words, the audio codec 12 is configured for generating an analog signal according to the decoded audio data. For example, the audio codec 12 can convert the digital audio data which is decoded and processed by a digital signal process, to the analog signal by the digital-to-analog converter, and play the digital audio data by the sound unit 13.

The sound unit 13 is a transducer capable of converting an electronic signal into an acoustic wave. In more detail, the sound unit 13 comprises an electromagnet, a coil and a speaker diaphragm (not shown). The sound unit 13 generates the acoustic wave according to the current frequency of the analog signal received. For example, when a current flows through the coil to generate an electromagnetic field, the sound unit 13 can make a frequency of the note C sound by outputting an alternating current with 256 Hz. When the coil and the speaker diaphragm vibrate together, air around is pushed to vibrate correspondingly, so the sound unit 13 generates sound. The sound unit 13 can be an electromagnet loudspeaker, a piezoelectric loudspeaker, an electrostatic loudspeaker, or a plasma arc loudspeaker, however, the present disclosure is not limited thereto.

The clock unit 14 is a resonant circuit, such as a quartz piezo-electric oscillator or other RC circuit. According to the embodiment of the present disclosure, the clock unit 14 is configured for generating a synchronous signal which is provided to the master speaker apparatus 1 and other speaker apparatuses for synchronization. In more detail, frequencies of audio played in each of the speaker apparatuses are slightly different from each other due to the synchronous signals generated by the speaker apparatuses. The difference in timings of the synchronous signals causes interference or non-sync during playback, which results in a worse user experience. Therefore, according to the embodiment of the present disclosure, the clock unit 14 generates the synchronous signal to enable synchronization between audio played by the master speaker apparatus 1 and other slave speaker apparatus. It is noted that the clock unit 14 is coupled to the synchronous signal output which is not shown in FIG. 1. The clock unit 14 of the master speaker apparatus 1 outputs the synchronous signal which is the outputted synchronous signal CLOCK_OUT, to the slave speaker apparatuses via the synchronous signal output.

The micro control unit 15 is a core computing part for processing signal, data or instructions in the master speaker apparatus 1. In detail, the master speaker apparatus 1 requests the audio codec 12 for the decoded audio data, and the micro control unit 15 performs the digital signal process on the received decoded audio data. For example, the micro control unit 15 performs signal equalization of multiple equalization modes, or performs selection of channel output modes on the audio data received by the communication unit 11. The equalization mode comprises a bass mode, a mediant mode, a treble mode or other kind of equalization mode such as smoothness mode, and the channel output mode comprises a left-channel mode, a right-channel mode or a dual-channel mode. Alternatively, the micro control unit 15 further controls the communication unit 11 broadcasting the audio data received.

The button unit 16 is a button configured for controlling the equalization mode or the channel output mode of the master speaker apparatus 1. The button unit 16 can be implemented by a press button or a DIP button, however, the present disclosure is not limited thereto. The button unit 16 may comprise a bass mode button, a mediant mode button, a treble mode button, other equalization mode button, a left-channel mode button, a right-channel mode button or a dual-channel mode button. In addition, the button unit 16 can also comprise a volume control button, an on/off switch, a playback button, a pause button and so on; however, the present disclosure is not limited thereto. For example, the button unit 16 is provided for users to select the mode, so as to control the micro control unit 15 executing the computing process according to signal instructions of different modes, to equalize the audio data or select different channels. In addition, users can generate a signal for adjusting the volume via the volume control button of the button unit 16, and the button unit 16 transmits the control signal for adjusting the volume to the micro control unit 15 for performing processing and controlling the sound unit 13 according to the control signal to adjust the volume of sound.

The power management unit 17 is a micro controller with integration management, configured for centrally managing multiple separate traditional power management ICs, and the traditional power management IC comprises a low dropout linear regulator (LDO) or a DC/DC converter. The power management unit 17 is coupled to a power input (not shown) or an internal part of the battery unit 18. The power management unit 17 receives an external power via the power input 18 of the master speaker apparatus 1 or the driving power of the internal elements of the master speaker apparatus 1 is directly provided by the internal part of the battery unit 18. It is noted that the power management unit 17 can improve the power conversion efficiency and lower loss of the electric power of the battery unit 18.

While receiving the external power such as inputted power DC_IN, the power management unit 17 charges the battery unit 18 simultaneously. In detail, the battery unit 18 is a device capable of transforming the stored chemical energy into electric power, or transforming the electric power into chemical energy for storing. The battery unit 16 can be a fuel cell, a NiMH battery, or solar battery and so on; however, the present disclosure is not limited thereto. In addition, according to an embodiment of the present disclosure, the master speaker apparatus 1 further comprises a power output, which is not shown in FIG. 1. The power output is configured for outputting the inputted power DC_IN received from the power input to the slave speaker apparatus. In other words, other slave speaker apparatuses can receive the outputted power DC_OUT via the power output of the master speaker apparatus 1.

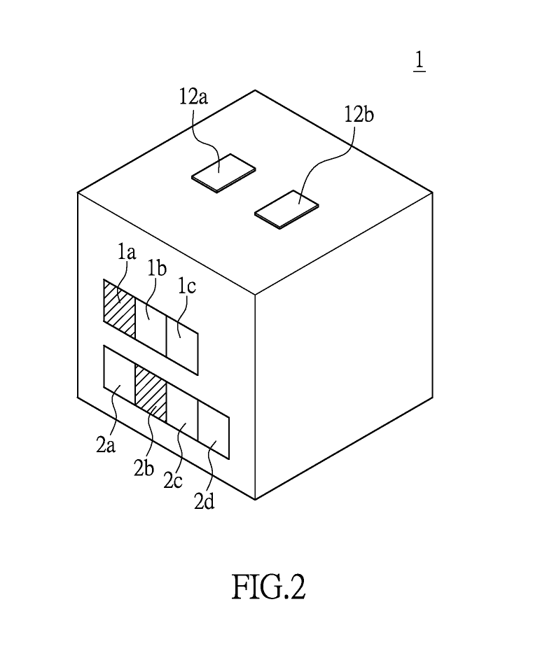

Please refer to both of FIG. 1 and FIG. 2. FIG. 2 is a schematic view of a master speaker apparatus of an embodiment according to the present disclosure. The master speaker apparatus 1 is shaped as a cubic structure, and comprises a power input which is not shown in the figure, a power output 12a, a synchronous signal output 12b, a dual-channel mode button 1a, a left-channel mode button 1b, a right-channel mode button 1c, a bass mode button 2a, a mediant mode button 2b, a treble mode button 2c and another equalization mode button 2d.

The power input of the master speaker apparatus 1 is connected to a voltage transformer to receive DC power. The power input can be disposed at the back surface or at least one side surface of the master speaker apparatus 1. In addition, the button unit 16 is provided for users to select the mode, so as to control the micro control unit 15 executing the computing processing according to signal instructions of different modes, to equalize the audio data or to select different channels. For example, in practical applications users may press the dual-channel mode button 1a to control the master speaker apparatus 1 operating in dual-channel mode; alternatively, users may press the mediant mode button 2b to control the master speaker apparatus 1 to operate in the mediant mode.

It is noted that the at least one side surface of the master speaker apparatus 1, such as upper side surface, can be provided with the power output 12a and the synchronous signal output 12b. The power output 12a and the synchronous signal output 12b are configured for being connected electrically to a power input and the synchronous signal input of the other slave speaker apparatus, respectively. In other words, other slave speaker apparatuses can receive the outputted power DC_OUT via the power output 12a of the master speaker apparatus 1, and receive the synchronous signal CLOCK_OUT outputted from the master speaker apparatus 1 via the synchronous signal output 12b.

According to an embodiment of the present disclosure, the exterior appearance of the master speaker apparatus 1 is a cubic structure, but the present disclosure is not limited thereto. The master speaker apparatus 1 can be shaped like a regular triangle or other shape. It is noted that the outer wall of the master speaker apparatus 1 can be provided with a velcro, a tenon or other mechanical structure, so that the master speaker apparatus 1 and other slave speaker apparatus can be connected tightly in a stack arrangement.

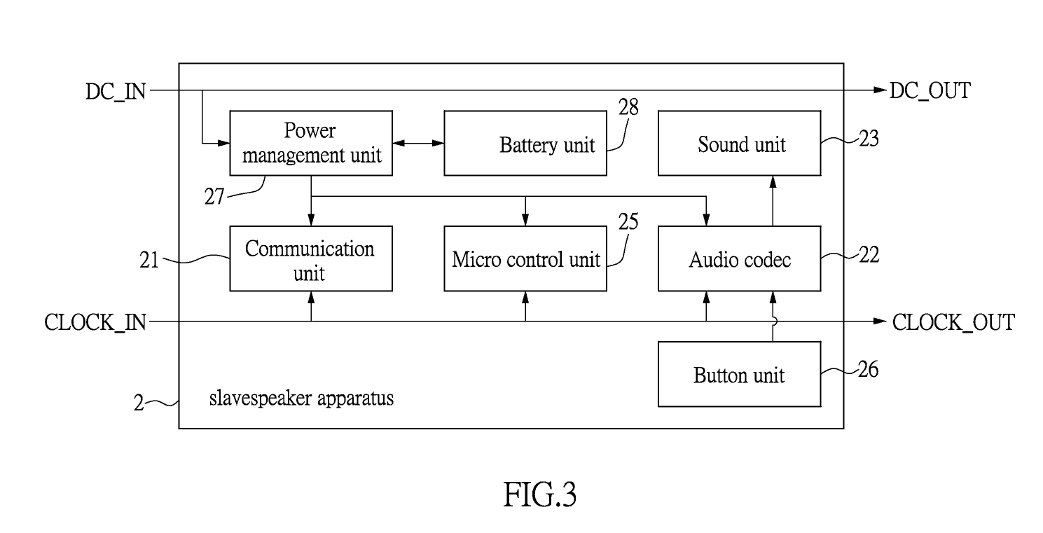

Next, please refer to FIG. 3 which is a block diagram of a slave speaker apparatus of an embodiment according to the present disclosure. The slave speaker apparatus 2 comprises a communication unit 21, an audio codec 22, a sound unit 23, a micro control 25, a button unit 26, a power management unit 27 and a battery unit 28. These components and their connect relationships are the same as that shown in FIG. 1, so their detailed description is omitted. The following paragraph illustrates the differences between the FIG. 3 and the FIG. 1.

The communication unit 21 of the slave speaker apparatus 2 is configured for receiving the audio data broadcasted by the master speaker apparatus 1. For example, through the communication unit 11, the master speaker apparatus 1 is wirelessly connected to a smart phone or a tablet computer ready to play audio, and the master speaker apparatus 1 further broadcasts the received audio data to the slave speaker apparatus 2 in its neighborhood through the communication unit 11. Next, the slave speaker apparatus 2 receives the audio data broadcasted by the communication unit 21.

Next, please refer to FIG. 1, FIG. 2 and FIG. 3. In more detail, the slave speaker apparatus 2 is not provided with a clock unit. By a synchronous signal input not shown in the figures, the slave speaker apparatus 2 receives the synchronous signal CLOCK_OUT outputted from the synchronous signal output 12b of the master speaker apparatus 1 shown in FIG. 1. The synchronous signal CLOCK_OUT outputted from the synchronous signal output 12b of the master speaker apparatus 1 is the synchronous signal CLOCK_IN inputted from the synchronous signal input of the slave speaker apparatus 2 shown in FIG. 3. By receiving the synchronous signal of the master speaker apparatus 1, the slave speaker apparatus 2 can synchronize with the communication unit 11, audio codec 12 and micro control unit 15 in processing audio data.

It is noted that the slave speaker apparatus 2 further comprises a synchronous signal output coupled to the synchronous signal input. The synchronous signal output and the synchronous signal input are not shown in the figures. For synchronization, the synchronous signal output is configured for outputting the synchronous signal from the master speaker apparatus 1 to other slave speaker apparatus 2 which are coupled to each other. In more detail, one master speaker apparatus 1 can be connected with multiple slave speaker apparatuses 2 in series. According to the design of the synchronous signal input and the synchronous signal output, multiple slave speaker apparatuses 2 can receive the synchronous signal from the master speaker apparatus 1 simultaneously.

In addition, the slave speaker apparatus 2 receives the power DC_OUT outputted from the power output 12a of the master speaker apparatus 1 shown in FIG. 1 by a power input which is not shown in the figures. The power DC_OUT outputted from the power output 12a of the master speaker apparatus 1 is the power DC_IN inputted from the power input 21a of the slave speaker apparatus 2 shown in FIG. 3. In more detail, when the master speaker apparatus 1 is connected to an external power, the master speaker apparatus 1 receives the inputted power DC_IN, and the external power can be provided to multiple slave speaker apparatuses 2 connected in series by the power output 12a, and the power input 21a and the power output 22a of the slave speaker apparatus 2.

It is noted that the power received by the slave speaker apparatus 2 also can be used to charge the battery unit 28 in the slave speaker apparatus 2 simultaneously. In addition, while not receiving the external power, the battery units 18 and 28 inside the master speaker apparatus 1 and the slave speaker apparatus 2 can respectively provide the driving power. As those skilled in the art would realize, the embodiment according to the present disclosure does not limit the number of the slave speaker apparatuses 2 in the speaker system, and the user can purchase the slave speaker apparatuses 2 upon requirement and financial capacity to assemble the speaker system.

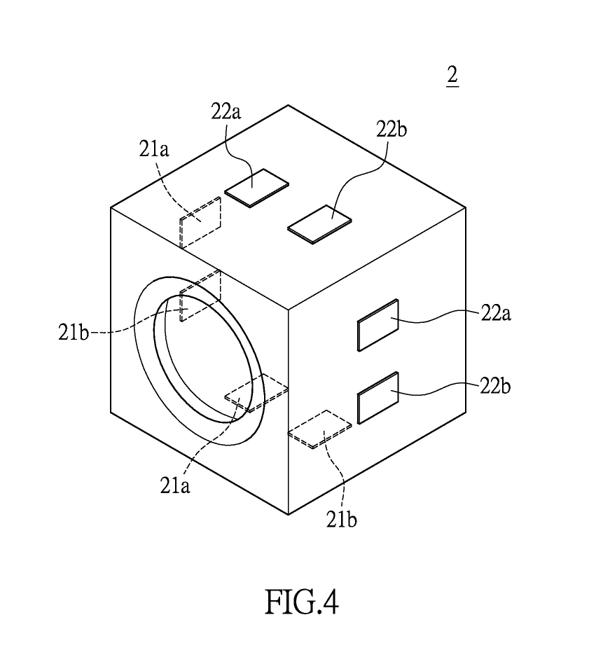

Please refer to FIG. 4 which is a schematic view of a slave speaker apparatus of the embodiment according to the present disclosure. The shape of the slave speaker apparatus 2 corresponds to shape of the master speaker apparatus and is a cubic structure. The slave speaker apparatus 2 comprises a power input 21a, a power output 22a, a synchronous signal input 21b and a synchronous signal output 22b. The power input 21a and the synchronous signal input 21b are located on at least one side surface of the slave speaker apparatus 2, and the synchronous signal output 22b and the power output 22a are located on at least another side surface.

According to the embodiment of the present disclosure, the power input 21a and the synchronous signal input 21b are located on the left side surface and lower side surface of the slave speaker apparatus 2, and the synchronous signal output 22b and the power output 22a are located on the right side surface and upper side surface of the slave speaker apparatus 2. However, the manufacturing company can adjust locations of the input ends and the output ends of the master speaker apparatus 1 and the slave speaker apparatus 2, such as the power input 21a, the power output 22a, the synchronous signal input 21b and the synchronous signal output 22b, upon requirement, to enable the speaker apparatuses to be connected tightly in stack arrangement.

In addition, the slave speaker apparatus 2 comprises a button unit which is not shown in the figures, as well as the master speaker apparatus 1 in FIG. 2. The function of the button unit of the slave speaker apparatus 2 is equal or similar to that of the button unit of the master speaker apparatus 1, so its detailed description is omitted.

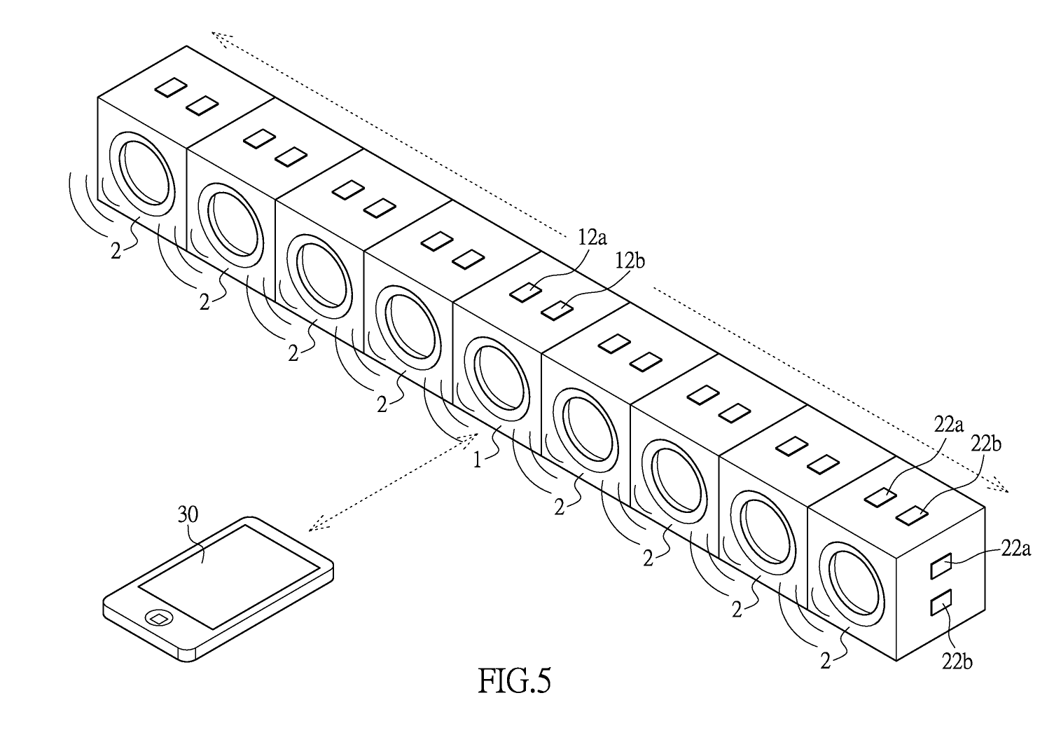

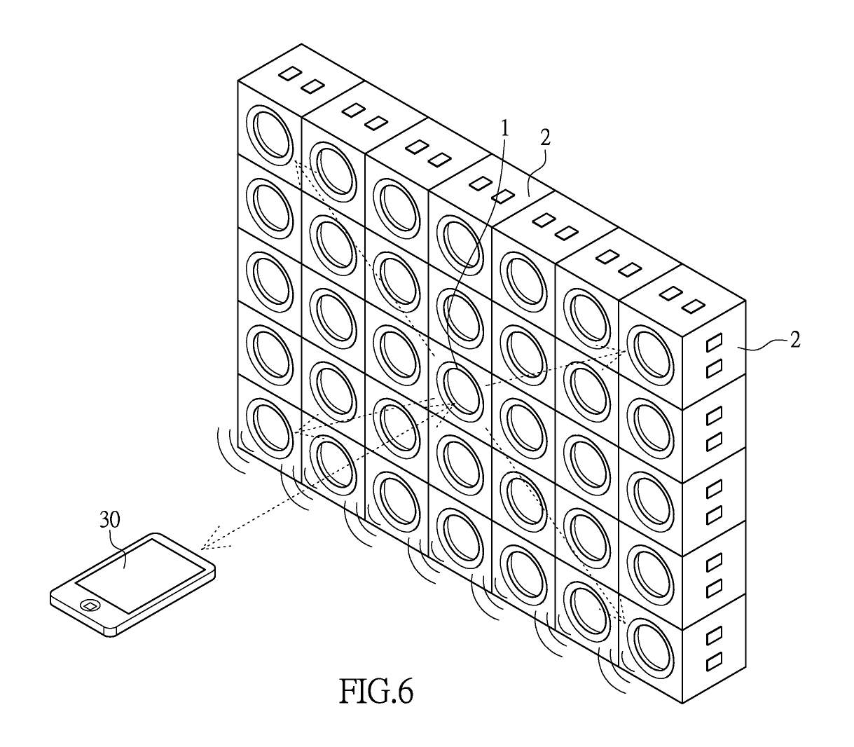

Next, please refer to FIG. 5 and FIG. 6 which are schematic views of a practical application of an embodiment according to the present disclosure. In practical application, users may connect the master speaker apparatus 1 with multiple slave speaker apparatuses 2 cooperatively according to their requirements. The master speaker apparatus 1 and the slave speaker apparatuses 2 are connected in series by the power output 12a and 22a, the synchronous signal input 21b, the synchronous signal output 12b and 22b, and the power input 21a, to provide the synchronous signal and the driving power to the slave speaker apparatuses 2. According to an embodiment of the present disclosure, the master speaker apparatus 1 is located among the slave speaker apparatuses 2. After receiving audio data from the media apparatus 30, the master speaker apparatus 1 broadcasts the audio data to the connected slave speaker apparatuses 2.

In FIG. 5, it is noted that the slave speaker apparatus 2 at the left side of the master speaker apparatus 1 can be adjusted to the left-channel mode, and the slave speaker apparatus 2 at the right side of the master speaker apparatus 1 can be adjusted to the right-channel mode, and the master speaker apparatus 1 is adjusted to the dual-channel mode, by using the button unit of the master speaker apparatus 1 and the slave speaker apparatus 2. In FIG. 6, users can place the master speaker apparatus 1 at the middle location, and the master speaker apparatus 1 is connected with the slave speaker apparatuses 2 in stack arrangement to form a speaker wall. The adjusting mode and arrangement are taken as an example for illustration, however, a user could adjust the mode and arrangement flexibly upon practical requirements. In conclusion, the present disclosure does not limit the way of arrangement and adjusting mode of the master speaker apparatus 1 and the slave speaker apparatus 2.

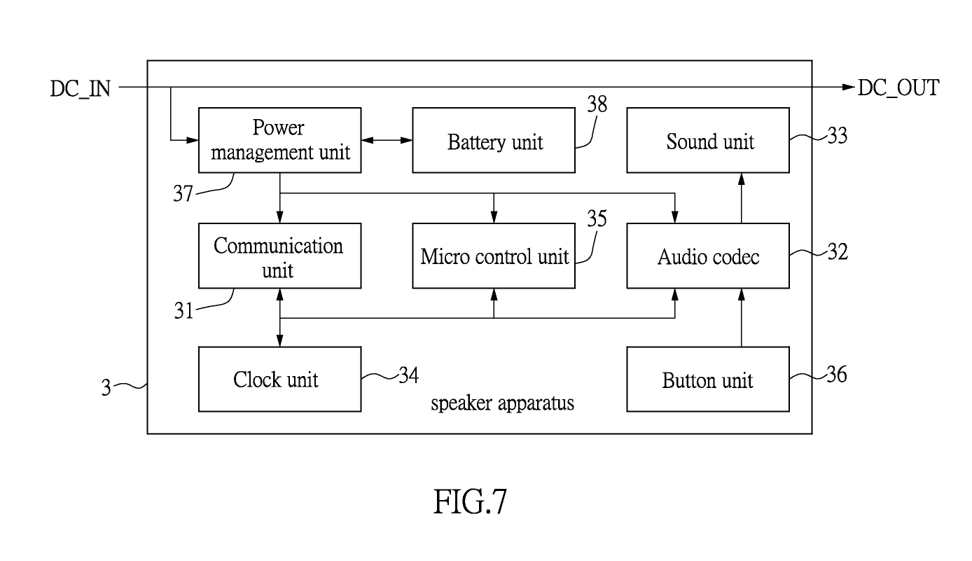

Please refer to FIG. 7 which is a block diagram of a speaker apparatus of another embodiment according to the present disclosure. The speaker apparatus 3 comprises a communication unit 31, an audio codec 32, a sound unit 33, a clock unit 34, a micro control unit 35, a button unit 36, a power management unit 37 and a battery unit 38. These components and their connection relationships are the same as that shown in FIG. 1, so their detail description is omitted. The following paragraph illustrates the differences between the FIG. 7 and the FIG. 1.

According to an embodiment of the present disclosure, a user can operate the button unit 36 of the speaker apparatus 3 to set the speaker apparatus 3 as a master speaker apparatus or a slave speaker apparatus. For example, the button unit 36 may comprise a master mode button and a slave mode button which are not shown in the figures. The user can further control the micro control unit 35 selecting speaker apparatus 3 to operate in the master mode or the slave mode by using the master mode button and the slave mode button.

When the speaker apparatus 3 is switched to the master mode by the button unit 36, the clock unit 34 generates a synchronous signal, and the synchronous signal is then transmitted to other slave speaker apparatus 3. The speaker apparatus 3 further broadcasts audio data received from a media apparatus, such as the media apparatus 30 shown in FIG. 6, to other slave speaker apparatus 3 by the communication unit 31. In addition, when the speaker apparatus 3 is switched to the slave mode by the user, by the communication unit 31, the clock unit 34 receives the synchronous signal transmitted from the speaker apparatus 3 which is set as master mode, for synchronization, and the speaker apparatus 3 receives the broadcasted audio data.

It is noted that the speaker apparatus 3 set as the master mode can transmit the synchronous signal by broadcasting, and when receiving the synchronous signal from the speaker apparatus 3 set as the master mode, the speaker apparatus 3 set as the slave mode further synchronizes the internal clock unit 34, and the clock unit 34 further adjusts the synchronous signal of the audio codec 32 and the micro control unit 35 for signal processing. In other words, the speaker apparatus according to an embodiment of the present disclosure can synchronize the audio data by the clock unit 34 and the broadcasting of the communication unit 31.

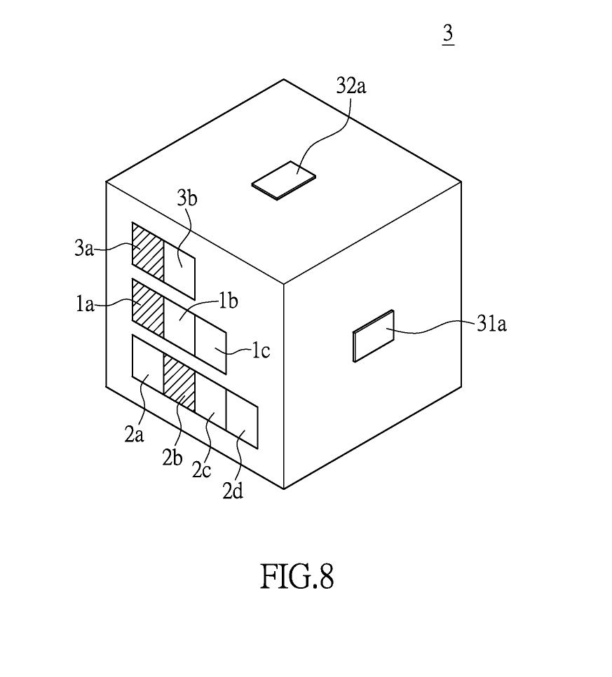

Please refer to FIG. 8 which is a schematic view of a speaker apparatus of an embodiment according to the present disclosure. The exterior appearance of the speaker apparatus 3 is substantially similar to that of the master speaker apparatus 1 shown in FIG. 3, but the difference between them is that the speaker apparatus 3 further comprises a master mode button 3a and a slave mode button 3b configured for providing for the user to select the speaker apparatus 3 to be in the master mode or the slave mode. It is noted that each of speaker apparatuses 3 has a clock unit, so one speaker apparatus 3 can synchronize with other speaker apparatus 3 by the communication unit. Therefore, the speaker apparatus 3 is not provided with the synchronous signal input and the synchronous signal output. In addition, the speaker apparatus 3 just comprises the power output 32a and the power input 31a which are located on the upper side surface and right side surface of the speaker apparatus 3. The speaker apparatus 3 does not comprise the synchronous signal input and the synchronous signal output.

Effect of the Present Disclosure

To sum up, the speaker apparatus, speaker system and speaker apparatus transmission system according to the present disclosure can provide for a user to assemble a speaker apparatus by a more flexible way. In more detail, the user can adjust a required amount of speaker apparatuses by himself or herself upon demand by assembling a master speaker and at least one slave speaker. On the other hand, by wirelessly broadcasting audio data, the speaker system can prevent the problem that internal amplifiers connected in series will overload and make audio data transmission between speaker apparatuses more difficult when multiple traditional speaker apparatus are connected in series.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A speaker apparatus, comprising:
a communication unit, configured for wirelessly receiving and broadcasting audio data;
an audio codec, coupled to the communication unit, configured for decoding the audio data and generating an analog signal according to the decoded audio data;
a sound unit, coupled to the audio codec, configured for transforming the analog signal into an acoustic wave; and
a clock unit, coupled to the communication unit, synchronizing with at least one other speaker apparatus by a synchronous signal.

2. The speaker apparatus according to claim 1, further comprising:
a synchronous signal output, coupled to the clock unit;
wherein the synchronous signal is generated by the clock unit, and the synchronous signal output transmits the synchronous signal to the at least one other speaker apparatus.

3. The speaker apparatus according to claim 1, further comprising:
a micro control unit, coupled between the audio codec and the communication unit, configured for performing a digital signal process on the decoded audio data, wherein the audio codec transforms the decoded and processed audio data into the analog signal.

4. The speaker apparatus according to claim 3, further comprising:
a button unit, coupled to the micro control unit, configured for providing for a user to select an equalization mode or a channel output mode;
wherein the equalization mode is configured for controlling the micro control unit to perform an equalization process on the audio data.

5. The speaker apparatus according to claim 4, wherein the modulation mode is a bass mode, a mediant mode or a treble mode.

6. The speaker apparatus according to claim 4, wherein the channel output mode is a left-channel mode, a right-channel mode or a dual-channel mode.

7. The speaker apparatus according to claim 1, further comprising:
a button unit, coupled to the micro control unit, configured for providing a user to control the speaker apparatus switching to a first function mode or a second function mode;
wherein when the speaker apparatus is switched to the first function mode by the button unit, the clock unit generates the synchronous signal and the synchronous signal is transmitted to the at least one other speaker apparatus for synchronization therebetween by the communication unit, and the received audio data is further broadcasted to the at least one other speaker apparatus by the communication unit; when the speaker apparatus is switched to the second function mode by the button unit, the clock unit synchronizes with the another speaker apparatus by a synchronous signal received by the communication unit, and receives the audio data broadcasted by the another speaker apparatus.

8. The speaker apparatus according to claim 1, further comprising:
a power management unit, receiving an external power via a power input and providing a driving power to internal elements of the speaker apparatus.

9. The speaker apparatus according to claim 8, further comprising:
a battery unit, coupled to the power management unit, configured for outputting an internal power to the power management unit and providing the driving power to the internal elements of the speaker apparatus;
wherein when receiving the external power, the power management unit charges the battery unit simultaneously.

10. The speaker apparatus according to claim 8, further comprising:
a power output, configured for providing the received external power to the at least one other speaker apparatus which is connected with the power output.

11. A speaker apparatus, comprising:
a communication unit, configured for receiving audio data which has been broadcasted;
an audio codec, coupled to the communication unit, configured for decoding the audio data, and generating an analog signal according to the decoded audio data; and
a sound unit, coupled to the audio codec, configured for transforming the analog signal into an acoustic wave;
wherein the speaker apparatus synchronizes with a first speaker apparatus by a synchronous signal generated from the first speaker apparatus.

12. The speaker apparatus according to claim 11, further comprising:
a synchronous signal input, coupled to the communication unit, configured for receiving the synchronous signal generated from the first speaker apparatus; and
a synchronous signal output, coupled to the synchronous signal input, configured for further providing the synchronous signal to at least one second speaker apparatus for synchronization therebetween.

13. The speaker apparatus according to claim 11, further comprising:
a micro control unit, coupled to the audio codec, configured for performing a digital signal process on the received audio data.

14. The speaker apparatus according to claim 13, further comprising:
a button unit, coupled to the micro control unit, configured for providing a user to select an equalization mode or a channel output mode;
wherein the equalization mode is configured for controlling the micro control unit to perform an equalization process on the audio data.

15. The speaker apparatus according to claim 14, wherein the modulation mode is a bass mode, a mediant mode or a treble mode.

16. The speaker apparatus according to claim 14, wherein the channel output mode is a left-channel mode, a right-channel mode or a dual-channel mode.

17. The speaker apparatus according to claim 11, further comprising:
a power management unit, receiving an external power via a power input and providing a driving power to internal elements of the speaker apparatus.

18. The speaker apparatus according to claim 17, further comprising:
a battery unit, coupled to the power management unit, configured for outputting an internal power to the power management unit and providing the driving power to the internal element of the speaker apparatus;
wherein when receiving the external power, the power management unit charges the battery unit simultaneously.

19. The speaker apparatus according to claim 17, further comprising:
a power output, configured for providing the received external power to the second speaker apparatus which is connected with the speaker apparatus.

20. A speaker system, comprising:
a first speaker apparatus, comprising:
a first communication unit, configured for wirelessly receiving and broadcasting the audio data;
an first audio codec, coupled to the first communication unit, configured for decoding the audio data and generating a first analog signal according to the decoded audio data;
a first sound unit, coupled to the audio codec, configured for transforming the first analog signal into an acoustic wave; and
a clock unit, coupled to the communication unit, configured for generating a synchronous signal; and
a second speaker apparatus, comprising:
a second communication unit, configured for receiving the audio data which has been broadcasted;
an second audio codec, coupled to the second communication unit, configured for decoding the audio data and generating a second analog signal according to the decoded audio data; and
a second sound unit, coupled to the second audio codec, configured for transforming the second analog signal into the acoustic wave;
wherein the second speaker apparatus synchronizes with the first speaker apparatus by the synchronous signal generated from the clock unit of the first speaker apparatus.
